(19) United States
(12) Patent Application Publication
(10) Pub. No.: US 2006/0195253 A1
(43) Pub. Date: Aug. 31, 2006

(54) Advanced vehicle distance notification system

(76) Inventor: Portia Jean Flynn, Star, ID (US)

Correspondence Address: PORTIA JEAN FLYNN, 3050 N WING RD., STAR, ID, 83669, US

(21) Appl. No.: 11/176,092

(22) Filed: Jul. 7, 2005

Related U.S. Application Data
(60) Provisional application No. 60/586,478, filed on Jul. 8, 2004.

(51) Int. Cl. G01C 21/26

(52) U.S. Cl. 701/201; 701/213

(57) ABSTRACT

An advanced notification system that notifies and indicates on a base station the distance to a particular transportation vehicle, for example a school bus, to a base unit. This notifies passengers when to get ready for the bus arrival. The system includes an onboard vehicle position unit that uses GPS to calculate the vehicle location and sends out that location along with a route code to the base stations. The base station is programmed with a pickup location, is set to a route code, receives the periodic signal, calculates the distance to the vehicle, and gives visual and audio cues to the passengers as to the distance to the transportation vehicle, preparing them for the vehicle arrival.

This application is in continuance of the provisional patent application GPS Vehicle Monitor, application No. 60/586,478.

### BACKGROUND OF THE INVENTION

The problem of when a school bus is going to arrive has plagued families since schools began supplying transportation. Parents have to anticipate when the bus will arrive and get children ready ahead of time and to the stop. At which time the waiting game begins. Many factors can contribute to unreliable schedules including weather and vehicle malfunctions. After class, meeting a returning student is a game of patience.

With Amber alerts leading news reports, parents are no longer willing to let their children wait alone. This invention gives a visible and audible indication of how close a bus is to a pickup/drop-off location. Parents no longer have to wonder when the bus has arrived or when their children are home.

This also benefits the providers of the transportation. Bus drivers will not have to wait wondering if a child will show up to ride the bus. In an age of reduced public funding, ridership can directly affect matching dollars. Parents who are more at ease, are more likely to use publicly provided transportation. Record gas prices and the need to limit damage to the environment are other reasons to pursue inventions that aid the use of public transportation. Inconvenience is a major factor in the use of private vehicles over public transportation.

In addition this invention could be applied to any transportation system such as taxi pickup, dial a ride, senior transportation, or for those with physical disabilities.

Other inventions have employed bus notification systems, U.S. Pat. No. 4,713,661, U.S. Pat. No. 4,350,969, U.S. Pat. App. 20040083054, but none combine GPS determined bus distance notification and transmitter based communication and use time rather than distance as the reported parameters and or other communication protocols.

### SUMMARY OF THE INVENTION

This invention is related to the application of a GPS receiver and a wireless transmission device located in a vehicle in combination with a receiver device and a programmed pickup/drop-off location. The wireless device will transmit the location of the vehicle to a receiver that has a programmed pickup/drop-off location. The receiving device will receive the transmitted location of the vehicle and calculate the distance the vehicle is from the pickup/drop-off location and give a visible indication on how close the vehicle is to the pickup/drop-off location along with an audible indication. The direct benefit is that riders of the vehicle will know when the vehicle is approaching, how far away it is, and when it arrives at a pickup/drop-off location.

### OPERATION

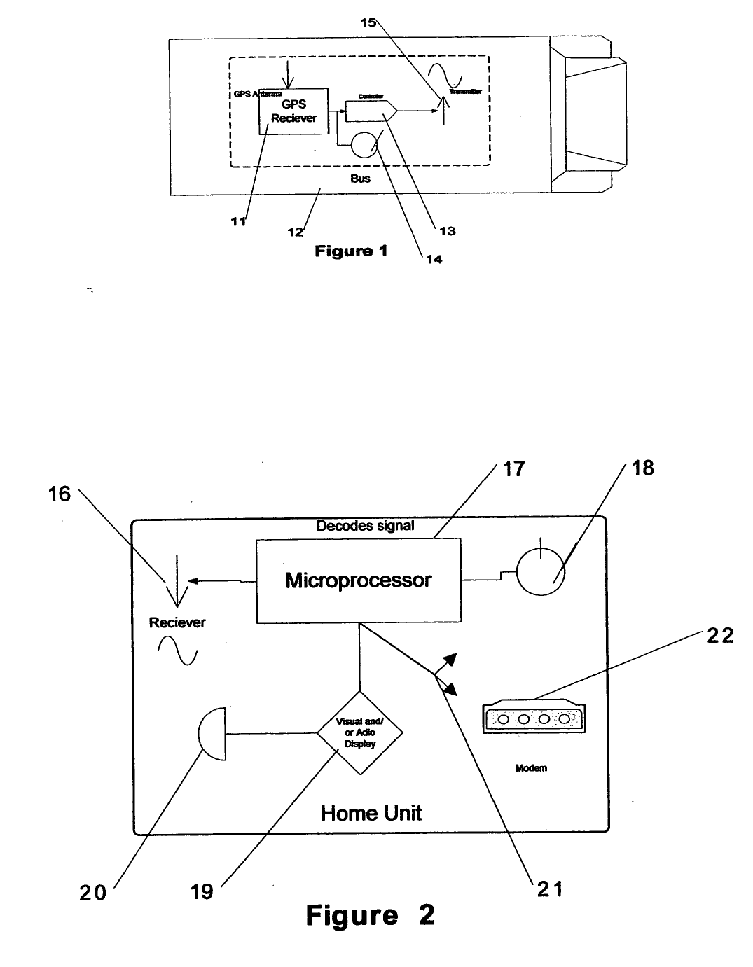

FIG. 1 shows a block diagram of a GPS receiver and transmission device. A GPS receiver 11 is installed in the vehicle 12. Powered by the vehicle's electrical system, GPS location information is sent to a controller device 13. Any of A number of commercially available microcontroller units can be used for this operation. The unit has a route selector 14 that allows the bus operator to indicate to the microcontroller what route the bus transmits. Upon a predeterminded interval, the controller encodes the location information along with a vehicle route identification code and transmits it with a wireless device 15. This type of transmission is already commonly done with Taxi services but could use one of many transmission methods.

The home indication unit FIG. 2 receives the encoded transmitted signal 17, as the vehicle approaches for pickup or drop-off. The home indication unit is preprogrammed with the pickup/drop-off location.

The home unit could be preprogrammed using any of a number of map and coordinate lookup services. Most addresses are now readily available. It could also be programmed using a portable GPS unit that could mark an exact location.

A controller device 17, interprets the signal from the receiver. The controller device receives the route code from the route input 18. If it receives the correct vehicle code, the controller device calculates the distance of the preprogrammed pickup/drop-off location. This is repeated every time the vehicle transmits location information. As the calculated distance becomes smaller the controller device begins lighting successive light indication bars to indicate that the vehicle is getting closer 19. The indicated distance could also be displayed on an LCD indicator 19. The controller also activates an audible signaling device 20 as the vehicle reaches a certain distance threshold. The sound signal volume can be adjusted and turned off if desired with a selection switch 21.

In addition to the visible indication from the light bars and an audible indication, the controller can also activate a modem 22 connected to a phone line and send a signal to an external paging device to give remote indication that the vehicle has reached the pickup/drop-off location.

### FIELD OF THE INVENTION

This invention is related to vehicle tracking and arrival indication for transportation systems including but not limited to a bus, train, taxi pickup, dial a ride, senior transportation, or any other vessel going to a known pickup or stop location.

1. A system to monitor the travel of a vehicle and indicate the vehicle's relative distance to a base station.

2. A method to monitor the position of a vehicle using GPS And periodically transmit that position using radio waves to a base station.

3. A method to program a base station position.

4. A method to calculate the distance of the vehicle to the base station.

5. A method to display the distance of the vehicle to the base station.

6. A method to give an audible cue that the vehicle is within a certain distance.
